(19) United States
(12) Patent Application Publication
(10) Pub. No.: US 2015/0302682 A1
(43) Pub. Date: Oct. 22, 2015

(54) Methods to Determine Luck Profile of a User

(71) Applicant: Zynga Inc., San Francisco, CA (US)

(72) Inventors: Shane Sareli, San Francisco, CA (US); Rudy Marsh, San Francisco, CA (US); Jeff Everett, San Francisco, CA (US)

(73) Assignee: Zynga Inc., San Francisco, CA (US)

(21) Appl. No.: 14/255,921

(22) Filed: Apr. 17, 2014

(51) Int. Cl. G07F 17/32; G07F 17/34

(52) U.S. Cl. CPC G07F 17/323; G07F 17/34

(57) ABSTRACT

Methods and computer programs for determining outcome of an online slot game includes receiving a spin action from a player, during game play of the online slot game. A profile graph is identified for the player. The profile graph is defined by a template with a plurality of peaks and valleys defined therein. The peaks represent a higher probability of generating a winning result and the valleys represent a higher probability of generating a losing result. Each spin action of the player corresponds to a distinct point in the profile graph. A number of virtual spins defined for the point corresponding to the spin action is determined based on location of the point in the profile graph. The defined number of virtual spins is performed and a highest or a lowest result is selected from the virtual spins for presenting to the player, in response to the spin action.

### BACKGROUND

1. Field of the Invention

The present embodiments relate to slot machines, and more specifically, to enhancing gaming experience of a user playing online slot machines.

2. Description of the Related Art

A goal of any online game is to keep a user engaged in play as long as possible, since longer engagement would relate to greater user satisfaction ultimately leading to higher revenues. Toward this end, video game developers are developing games and offering sufficient incentives within the games to keep the users engaged for longer period of times. Casino type games, such as slot machine games, thus try to maintain player interest in slot machines by providing sufficient payouts, in terms of free wins, prizes and/or jackpots.

In the online slot machine games, a player selects a spin action and, in response, a spin result is presented to the player. In typical online video games, a game developer may attempt to keep a player continually engaged by presenting different levels to master or different challenges to conquer. In the slot machine games, however, there are no such levels or challenges to master. A player simply performs spin actions and, in response, either experiences a win or a loss. Continuous user engagement in the slot games would result in a player experiencing periods of wins (otherwise termed “hot streak”), periods of losses (otherwise termed “cold streak”) and periods between hot and cold streaks (other termed “dry” periods), where the player is neither winning nor losing. In order to keep the players engaged for a longer period of time, it would be advantageous to minimize the dry periods so that the users have a higher game play satisfaction.

It is in this context that embodiments arise.

### SUMMARY

Various embodiments are presented for determining outcome of an online slot game. It should be appreciated that the present embodiments can be implemented in numerous ways, such as a method, an apparatus, a system, a device, or a computer program on a computer readable medium. Several embodiments are described below.

In one embodiment, a method for determining outcome of an online slot game is disclosed. The method includes receiving a spin action from a user during game play of the slot game. A profile graph associated with the user of the slot game, is identified. The profile graph is defined by a template with a plurality of peaks and valleys defined therein. The peaks represent a higher probability of winning and the valleys represent a higher probability of losing. Each spin action of the user corresponds to a distinct point in the profile graph. A number of virtual spins that needs to be performed in background for the spin action, is determined, wherein the number of virtual spins is defined in the identified profile graph of the user. A highest result or a lowest result from the virtual spins is selected for presenting to the user, in response to the spin action.

In another embodiment, a non-transitory computer-readable storage medium embedding program algorithm for determining outcome of an online slot game, is disclosed. The program algorithm includes program logic to generate a plurality of profile graphs based on expected return of play for the slot game. Each profile graph is defined by a template with peaks and valleys. Each point in the profile graph corresponds to a spin of a user. The peaks represent a higher probability of producing winning spin results and valleys represent a higher probability of producing losing spin results. The programming algorithm further includes program logic to identify a select one of the plurality of profile graphs for associating with a user for game play of the slot game, wherein the select profile graph is identified for a user session; program logic to determine number of virtual spins that needs to be performed in background for each spin received from the user during game play of the slot game, wherein the number of virtual spins is defined by the identified profile graph associated with the user; and program logic to select one of a highest spin result or a lowest spin result from the virtual spins for presenting to the user, in response to the spin received from the user. The program logic determines number of virtual spins and selection of highest or lowest spin result based on location of the point with the profile graph that corresponds to the spin received from the user.

Other aspects will become apparent from the following detailed description, taken in conjunction with the accompanying drawings.

### BRIEF DESCRIPTION OF THE DRAWINGS

The embodiments may best be understood by reference to the following description taken in conjunction with the accompanying drawings.

FIG. 1 illustrates a simplified block diagram of a system for determining outcome of an online slot game, according to one embodiment.

FIGS. 2A and 2B illustrate different parts of a profile graph and the number of virtual spins defined for the profile graph, according to one embodiment.

FIGS. 3A-3C illustrate exemplary profile graphs defined for a particular expected game play return for the slot game, according to some embodiments.

FIG. 4 illustrates a flowchart of operations for determining outcome of an online slot game, in accordance with one embodiment.

FIG. 5 illustrates a flowchart of operations for determining outcome of an online slot game, in accordance with an alternate embodiment.

FIG. 6 shows a block diagram illustrating a social-gaming network architecture, according to one embodiment.

FIG. 7 illustrates an implementation of a Massively Multiplayer Online (MMO) infrastructure, according to one embodiment.

FIG. 8 illustrates an example network environment suitable for implementing embodiments.

FIG. 9 illustrates an example computer system for implementing embodiments.

### DETAILED DESCRIPTION

The following embodiments describe methods and apparatus for determining outcome of an online slot game. It will be apparent, that the present embodiments may be practiced without some or all of these specific details. In other instances, well known process operations have not been described in detail in order not to unnecessarily obscure the present embodiments.

The embodiments provide ways to generate a plurality of profile graphs for an online slot game and associate one of the plurality of profile graphs to a player for a game play session. Each profile graph includes a plurality of points, with each point related to an actual spin received from the player. Each point in the profile graph is associated with a number of virtual spins to be performed in the background by a server for the corresponding actual spin received from a player. An algorithmic formula defined within a game manager of the online game, is used to generate the plurality of profile graphs for the slot game based on expected return of play and identify a specific one of the profile graph to associate with the player of the online slot game during a particular game play session. When a spin action is received from the player, the formula determines the point in the profile graph that the spin action corresponds to, identifies the number of virtual spins that needs to be performed in the background in response to the spin action received from the player, and considers presenting either a highest or a lowest spin result to the player, in response to the spin.

The embodiments thus provide ways to define a type of game play experience the player should have and assign a specific profile graph for the player that is configured to provide the play experience. The selected profile graph is designed to provide a defined game play return for the slot game. The profile graph that is assigned to the player provides sufficient variance in lucky and unlucky streaks while providing an expected return, to keep the players sufficiently engaged and interested in the slot game. With the general understanding of the invention, various embodiments for determining outcome of an online slot game will now be described with reference to the enclosed drawings.

It should be noted that the various embodiments are described herein with reference to an online slots game, to provide an understanding. It should, however, be noted that the principles may be extended to other online games that benefit from keeping a player engaged for a longer period of time. The embodiments described herein should therefore not be interpreted to be exclusive or limiting, but rather exemplary or illustrative.

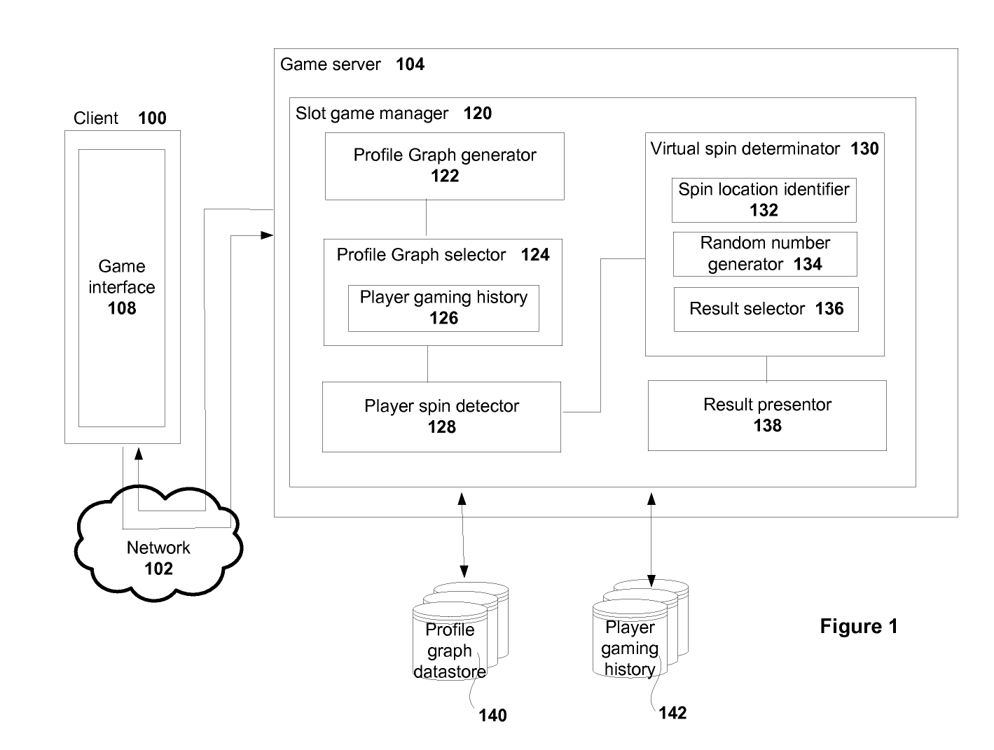

FIG. 1 is an illustrative embodiment of a system used for determining outcome of an online slot game. The system includes a server 104, such as a game server, executing the online slot game, according to one embodiment. The server 104 hosting the online slot game includes a game manager 120 having a plurality of modules, such as a profile graph generator module 122, a profile graph selector module 124, a player spin detector module 128, a virtual spin determinator 130, and a result presentor module 138. The profile graph selector 124, in turn, includes a player gaming history sub-module 126. The virtual spin determinator 130, in turn, includes a plurality of sub-modules, such as spin location identifier module 132, a random number generator module 134 and a result selector module 136. The game manager 120 interacts with one or more data stores to store and retrieve appropriate game related data. For example, the game manager may interact with a profile graph datastore 140 to store and retrieve profile graph for a player, and a player gaming history datastore 142 to retrieve a player's gaming history. The game manager may interact with additional datastores, such as player datastore (not shown) to obtain information related to the player, game datastore (not shown) to view and select the games available for game play on the server, etc.

A player, in one embodiment, initiates access to the online game executing on the server utilizing a game interface 108 on a client device 100 that is executing a computer program, such as a web browser. In another embodiment, the client may execute other computer programs other than the web browser to initiate interaction with the game executing on the server 104 through the game interface 108. The game interface facilitates transmission of command and data between the client 100 and the various modules of the game manager 120 executing on the server 104.

In one embodiment, the game manager 120 provides access to the online game and manages the game operations for the player. The various modules within the game manager 120 are configured to interact with each other to perform the respective game operations of the online slot game. In addition, the various modules within the game manager access and manage game related data stored in the various databases during the execution of the online game. The profile graph generator 122 is used to generate a plurality of profile graphs for the online slot game for various expected game returns. The profile graph generator 122, in one embodiment, is configured to generate a plurality of profile graphs for each expected game return. The game return may be defined as a return provided to player in the form of game related rewards, such as game points, game prizes, game incentives (free spins), game payouts (either virtual or real), other quantifiable or non-quantifiable game awards or tools, etc. For example, the profile graph generator may generate one set of profile graphs for an expected game return of about 80% or 85% and another set of profile graphs for an expected game return of 70% or 90%. Each profile graph generated by the profile graph generator includes a plurality of peaks and valleys, with each peak providing a higher probability of winning and each valley providing a higher probability of losing. The frequency and placement of peaks and valleys within the generated profile graph are designed such that the probable winnings at the peaks and probable losses at the valleys within the profile graph average out to the expected game return.

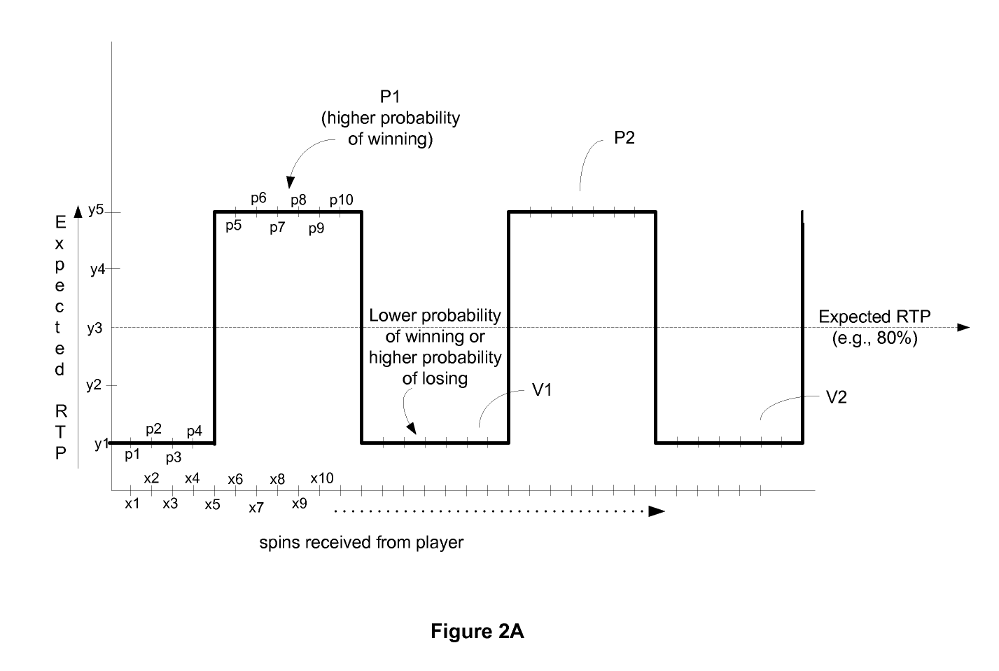

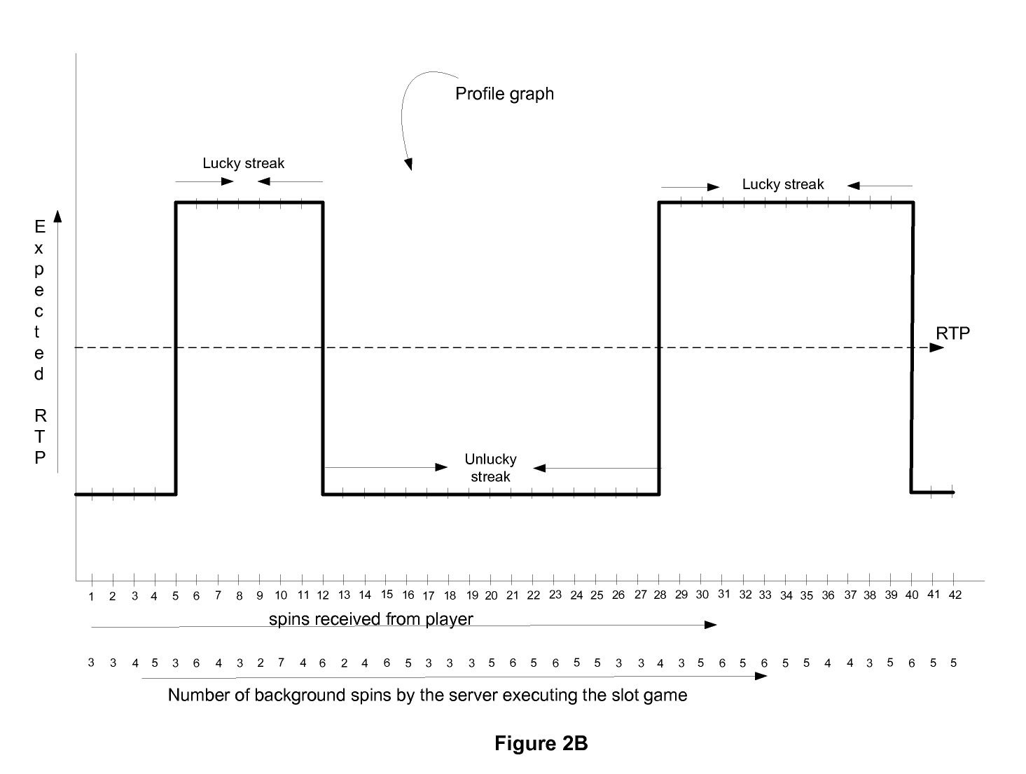

FIG. 2A illustrates an exemplary profile graph generated by a profile graph generator module 122. The profile graph includes a plurality of points, p1, p2, p3 . . . p10, etc. corresponding to points x1, x2, x3, etc., on the x-axis. The profile graph also includes a plurality of peaks, represented by P1, P2, etc., where the probability of winning is high and valleys, represented by V1, V2, etc., where the probability of losing is high. The profile graph also shows the expected game play return for the profile graph, represented by the normal broken line at (0, y3) coordinate. In the embodiment illustrated in FIG. 2A, the expected game play return is defined to be about 80%.

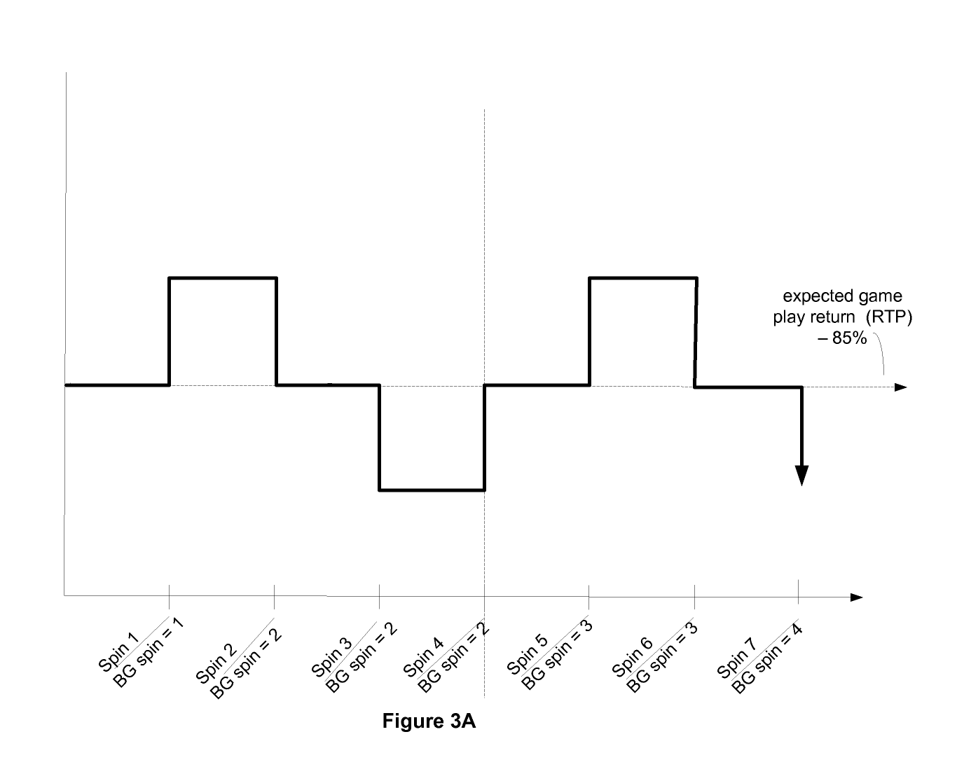

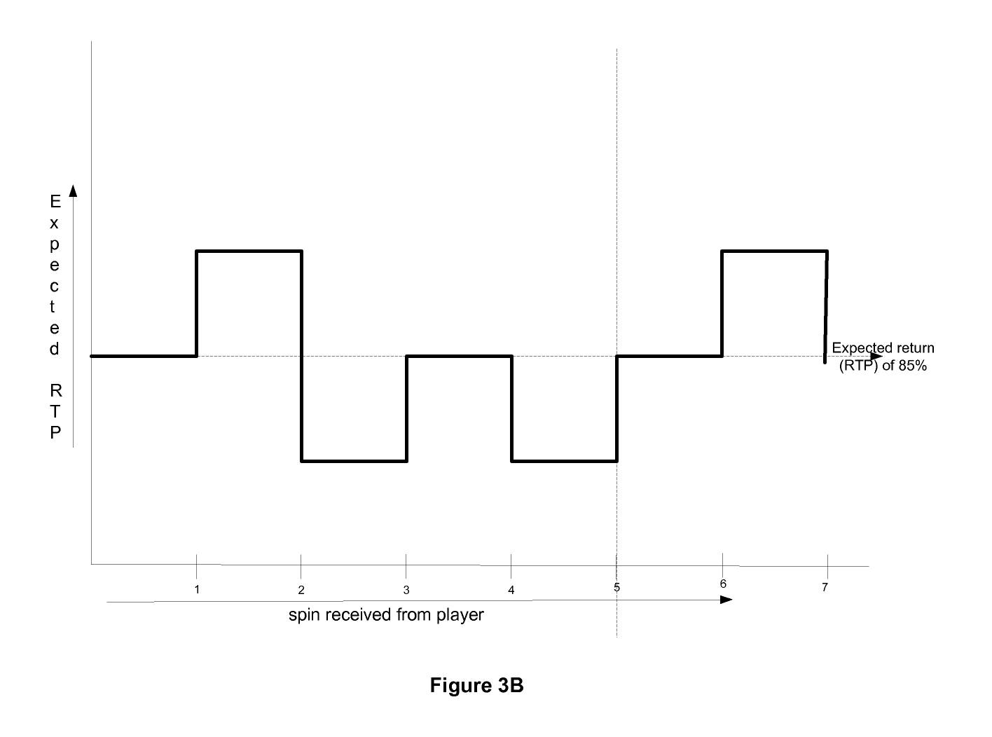

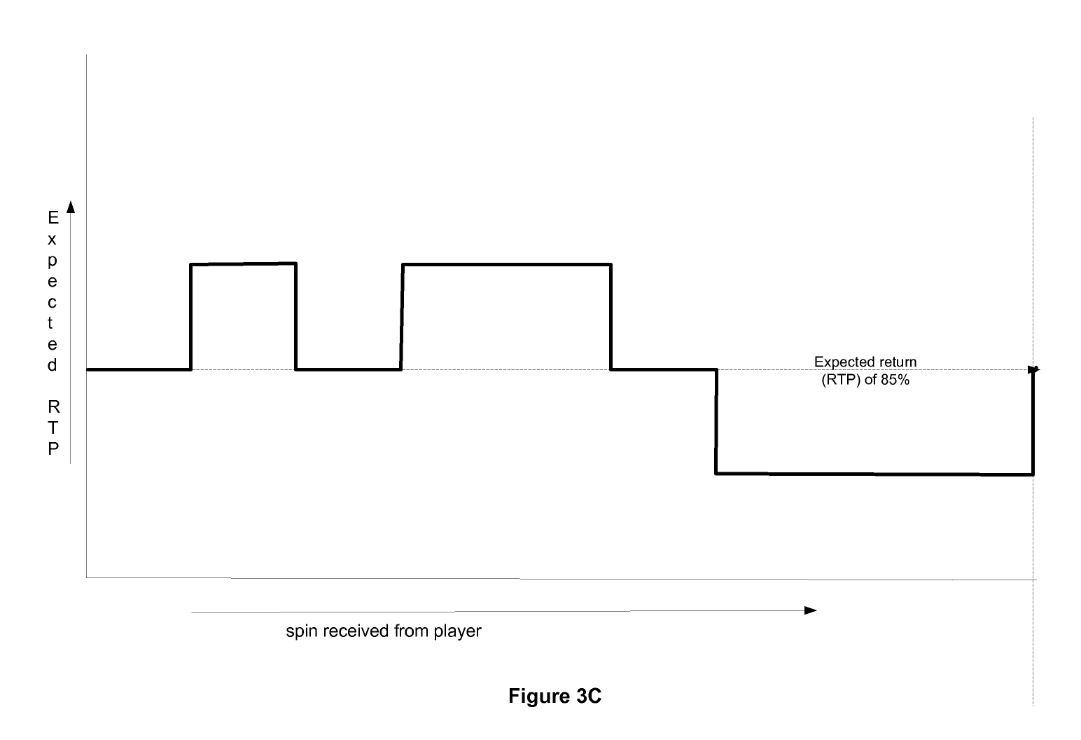

In one embodiment, the plurality of profile graphs may be generated for a particular expected game return by distributing the peaks and valleys differently to provide distinct game play experience. FIGS. 3A-3C illustrate exemplary profile graphs generated by the profile graph generator for the particular game return (RTP) of about 85%, for example. As illustrated in FIG. 3A, the profile graph generated by the profile graph generator identifies a plurality of points distributed along the peaks and valleys defined in the profile graph. Each spin action received from the player is associated with a spin number and corresponds to a distinct point on the profile graph. The profile graph identifies the number of virtual spins specified for each point on the profile graph identified by the respective spin number. The expected game play return is identified by the broken horizontal line and, as illustrated, the expected game play return is about 85%. In one embodiment, a vertical broken line identifies an end of a pattern in the profile graph, which is repeated over time in the profile graph to ensure the player is provided with the expected game play return. Alternately, in another embodiment, the profile graph may not have any repeating pattern. Instead, the profile graph generator may generate the profile graph with random distribution of the peaks and valleys while ensuring the expected game play return is provided to the player during the online game session.

FIG. 3B illustrates an alternate profile graph generated by the profile graph generator for the same expected game play return of 85%. As can be observed, the peaks and valleys of the profile graph illustrated in FIG. 3B are distributed differently than what was presented in the profile graph of FIG. 3A. Additionally, the number of virtual spins corresponding to different points in the profile graph illustrated in FIG. 3B is different from the ones specified in the profile graph illustrated in FIG. 3A. FIG. 3C illustrates yet another profile graph generated by the profile graph generator for the same expected game play return of 85% with different distribution of peaks and valleys and different virtual spins associated with each point on the profile graph. The variations in the distribution of peaks and valleys and variations in the assignment of the virtual spins are defined to provide the same expected game play return while allowing the player to have different game play experience each time the player plays the online slot game. The expected game play return defined for the profile graph is exemplary and should not be considered restrictive or limiting. Higher or lower expected game play return may be considered and the profile graphs generated by the profile graph generator will accommodate such expected returns by distributing the peaks and valleys and specifying/assigning the virtual spins accordingly.

The different profile graphs for the online slot game generated by the profile graph generator 122 are stored in the profile graph datastore 140 and retrieved for assigning to a player during game play. In some embodiments, the profile graph generator may generate profile graphs that that are geared toward more winnings than losses. In such embodiments, the generated profile graphs may, for example, have more peaks than valleys to provide higher probability of winning. For example, when a player is new to playing the online game or when a player installs the game on a new device and uses the new device to access and play the online game, the profile graph generator may generate a profile graph for a player that is geared toward higher winnings and, hence, greater game play return. In another example, the profile graph generator may generate a profile graph for a player depending on a player's actions in the online game (i.e. greater risk taker or places higher bets) or game state.

The profile graph selector 124 is configured to access the various profile graphs for the online slot game that are stored in the profile graph datastore 140 and to identify a specific profile graph for assigning to a player during the online game play. When a player accesses the online slot game for game play, the profile graph selector 124 determines an expected game play return for the online slot game, identifies a subset of the profile graphs that are defined for the expected game play return and selects a specific one of the profile graph from within the subset for assigning to the player. The profile graph selector 124 determines a type of game play experience the player should have for the expected game return and selects the appropriate profile graph accordingly. In order to determine the type of game play experience and to assist in selecting the appropriate profile graph, the profile graph selector 124 engages a player gaming history sub-module 126.

The player gaming history 126 determines the type of game play the player was engaged in prior to the current online game session and selects the profile graph in accordance to the type of game play. Toward this end, the player gaming history sub-module 126 queries the player gaming history datastore 142 to determine the game play history of the player, analyzes the game play history to determine the player's game play attributes, such as access frequency for the game, duration of game play, etc., and use the game play attributes to select an appropriate profile graph. For example, the game play attributes of a player obtained from the game play history may indicate that the player accesses the online slot game frequently and each time plays for a short period of time. The player gaming history sub-module 126 determines the access frequency attribute and duration attribute from the player's game play history and provides this information to the profile graph selector module 124. The profile graph selector 124 uses the provided information to select a profile graph based on the information provided. The selected profile graph for assigning to the player either matches or exceeds expected return of play so as to entice the player to play the online slot game for an extended period of time. In another example, if the player is a new player and does not have any player gaming history for the online slot game, the profile graph selector module 124 may select a profile graph that provides greater return of play to keep the player interested and engaged in the slot game. In addition to the access frequency and duration attributes, other game play attributes, such as player actions and/or player's game state, may be used to determine appropriate profile graph to assign to the player. In some embodiments, in addition to selecting the appropriate profile graph, the profile graph selector module may assign bonus points for certain player actions or game state. The bonus points are updated to the player's game asset, which may be used to influence the profile graph selection for the player and/or game play. In one example, a player's “wallet” size and/or size of bet placed in the online game may be used to select and assign appropriate profile graph. In one embodiment, the wallet size of a player is determined by the amount of game assets/properties, such as virtual real-estate properties, virtual game prizes, virtual cash, virtual winnings, virtual tools, real cash, etc., that are in the player's possession. Bet size, in one embodiment, may be defined as the amount or size of wager placed by the player during game play. For example, the player may be a high stakes player betting large amount of virtual asset every time the player plays the online game. In such examples, the profile graph selector module may select a profile graph that is commensurate with the player's game play attributes.

In an alternate embodiment, the profile graph selector module 124 may analyze the online game history of the player with reference to other online games, if available, to determine the type of game play experience the player is used to/desires and selects the profile graph accordingly. In one embodiment, the game history for the online slot game may not be available for the player. In another embodiment, the game history for the online slot game may be available for the player. Accordingly, in addition to or instead of providing the player's game play history in relation to the online slot game, the player gaming history sub-module 126 provides the player's game play history with reference to other online games to the profile graph selector 124 in order to allow the profile graph selector module 124 to determine the type of game play the player usually engages in and select the appropriate profile graph for the online slot game to entice and engage the player.

In another example, if the player is a frequent player and stays engaged in the online slot game for long periods of time every time he plays the online slot game, then the profile graph selector module 124 may select a profile graph that provides a reasonable expected return of play.

In one embodiment, the profile graph selector module 124 may select a different profile graph for assigning to the player every time the player returns to the online slot game. In this embodiment, the number of virtual spins that are performed in the background vary in accordance to the profile graph selected. The expected return of play for each time the player plays the online game may remain the same while the profile graph of the player has changed. Providing different profile graphs to a repeat player every time the player returns to play the online slot game enables the player to have different game play experience while enjoying same expected return.

The player spin detector module 128 detects the player's spin action at the game interface 108 on the client 100 and correlates it to a point in the profile graph assigned to the player during game play. The player spin detector 128 detects the spin action and assigns a spin number for the spin action in accordance to the number of spin actions received from the player for the current online game play session. The spin number is used to correlate with a corresponding point on the profile graph in order to determine if the spin action corresponds to a peak area where there is high probability of winning or a valley area where there is high probability of losing.

FIG. 2B illustrates an exemplary profile graph that may be assigned to a player during online game play. When a player's spin action is detected, the player spin detector 128 assigns a spin number for the online game during the current game session. The spin number correlates with a distinct point disposed in the peak, in the valley or between the peak and the valley within the profile graph. Correlating point information from the player spin detector 128 is provided to the virtual spin determinator module 130 to identify the number of virtual spins that needs to performed and to select a result from the virtual spins.

Referring simultaneously to FIGS. 1 and 2B, the virtual spin determinator module 130 identifies the point in the profile graph corresponding to the spin action and determines the number of virtual spins that is defined for the identified point in the profile graph. The profile graph generator, while generating the various profile graphs, may assign a number of virtual spins that need to be performed in the background for each point in the profile graph. The number of virtual spins for each point may be determined by engaging a formula within the profile graph generator module 122. The formula, in one embodiment, uses a probabilistic model to define the number of virtual spins that needs to be performed at each point in the profile graph to have a greater chance of obtaining the result specified by the profile graph. For example, the formula may determine that in order to have a greater probability of obtaining a winning result for a point disposed at the peak of the profile graph, at least 3 virtual spins needs to be performed. The formula, thus, determines the number of virtual spins for each point in the profile graph and stores this information with the profile graph in the profile graph datastore.

The spin location identifier sub-module 132 within the virtual spin determinator 130 will correlate the spin number of the spin action to a corresponding point in the profile graph and query information related to the profile graph to determine the number of virtual spins specified for the point in the profile graph. FIG. 2B illustrates an exemplary profile graph of a player that identifies the spin number on the x-axis and the corresponding number of virtual spins for each spin number defined for the profile graph. Upon identifying the number of virtual spins that need to be performed, the game manager on the server performs the specified number of virtual spins in the background for the spin action provided by the player.

In one embodiment, a random number generator module 134 is used for the virtual spins that are conducted in the background by the game manager 120 for each spin action obtained from the player during game play. It should be noted herein that the use of random number generator for the virtual spins is exemplary and should not be considered restrictive or limiting. Other forms of providing the virtual spins in the background by the server may also be engaged.

The result selector module 136 within the virtual spin determinator 130 is used to select the appropriate result from the virtual spins that are conducted in the background by the game manager. In one embodiment, based on the location of the point in the profile graph that corresponds to an actual spin action received from the player, the result selector module 136 may select either a highest result or the lowest result from all the virtual spins that were performed for the corresponding spin action from the player. For example, if the point corresponding to the spin action is in a peak portion of the profile graph, then the result selector module 136 may select the highest result from all the virtual spins for the spin action. On the other hand, if the point corresponding to the spin action is in the valley portion of the profile graph, the result selector module 136 may select the lowest result from all the virtual spins for the spin action. If the point falls in a portion of the profile graph that is on the normal line, the result selector module 136 may average the results of all the virtual spins.

The selected result is forwarded to the result presentor module 138, which verifies the result and forwards the result to the client for presenting at the game interface 108, in response to the spin action. It should be noted that the selected result for the peak may not always produce the winning or losing result but has a higher probability of producing the winning or losing result. The result selected for presenting to the player for the spin action may provide a higher or lower return than the expected return. However, it should be noted that the overall return for the game play may be a constant with variations in winnings and losings distributed over a period of game play. In one embodiment, the expected return is specific for a player's game session. In another embodiment, the expected return is specific for a game play.

The various embodiments described herein engage two levers for each spin action received from the player. The first lever is used to determine the number of virtual spins that needs to be performed in the background for each spin action received during game play and the second lever is used to select the highest (i.e., best) or lowest (i.e., worst) result from the virtual spins. The two levers are adjusted to keep the player continuously engaged and interested in the game play of the online slot game.

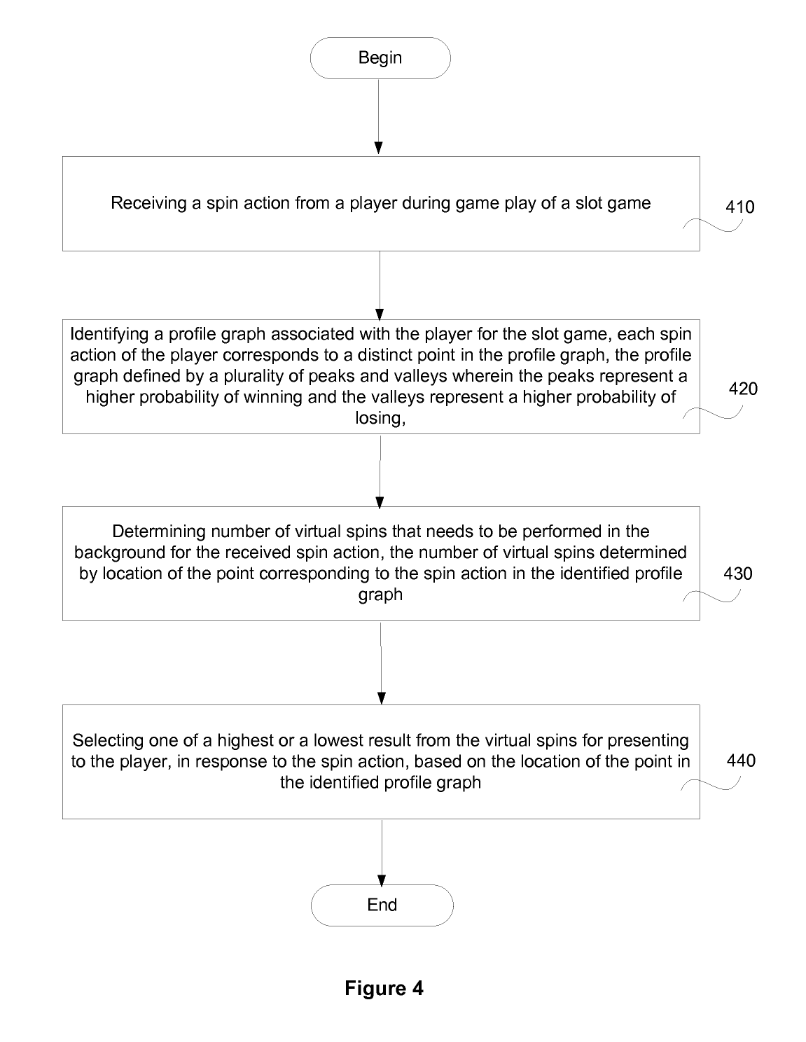

With the general understanding of the various modules of the system, methods for determining outcome of an online slot game will now be described with reference to FIG. 4, in one embodiment of the invention. The method begins at operation 410, wherein a spin action is received from a player during game play of an online slot game. The player may select the online slot game for game play and the server, such as a game server, provides access to the online slot game executing on the server and allows the player to interact with the game during a play session.

In response to a spin action received from the player, a profile graph is identified and associated with the player during the play session of the slot game, as illustrated in operation 420. The profile graph is selected from a plurality of profile graphs generated for the online slot game, wherein each of the plurality of profile graphs is associated with a particular game play return. Each of the profile graphs are defined by a plurality of points distributed along peaks and valleys defined therein. Each spin action received from the player corresponds to a distinct point in the profile graph selected for the player in the online game session. The peaks identify winning streaks experienced during game play with the points in the peak presenting a higher probability of generating a winning result. Similarly, the valleys identify losing streaks experienced during game play with points in the valleys presenting a higher probability of generating a losing result.

Once a location of a point corresponding to the spin action is identified in the profile graph, a number of virtual spins defined for the point is determined, as illustrated in operation 430. The virtual spins are defined as spins that need to be performed by a game manager, in response to an actual spin received from the player. The virtual spins are not made visible to the player during game play but are conducted in the background. The virtual spins are defined for each point in the profile graph when the profile graph is generated for a particular game play return of the online slot game and this information is stored with the profile graph in a datastore and retrieved when the particular point in the profile graph is reached. In some embodiments, the number of virtual spins for each and every point in the profile graph is the same. In some other embodiments, the number of virtual spins for different points in the profile graph is different.

Upon determining the number of virtual spins that needs to be performed for the spin action, the virtual spins are performed in the background and either a highest result or a lowest result is selected for presenting to the player, in response to the spin action, as illustrated in operation 440. The appropriate result is selected based on where the point corresponding to the spin action resides in the profile graph. For example, if the point corresponding to the spin action resides at one of the peaks defined in the profile graph, then the highest or best result is selected for presenting to the player. Alternately, if the point corresponding to the spin action resides at one of the valleys defined in the profile graph, then the lowest or worst result is selected for presenting to the player. The selected result acts toward providing the desired game play return defined for the profile graph selected for the player during game play.

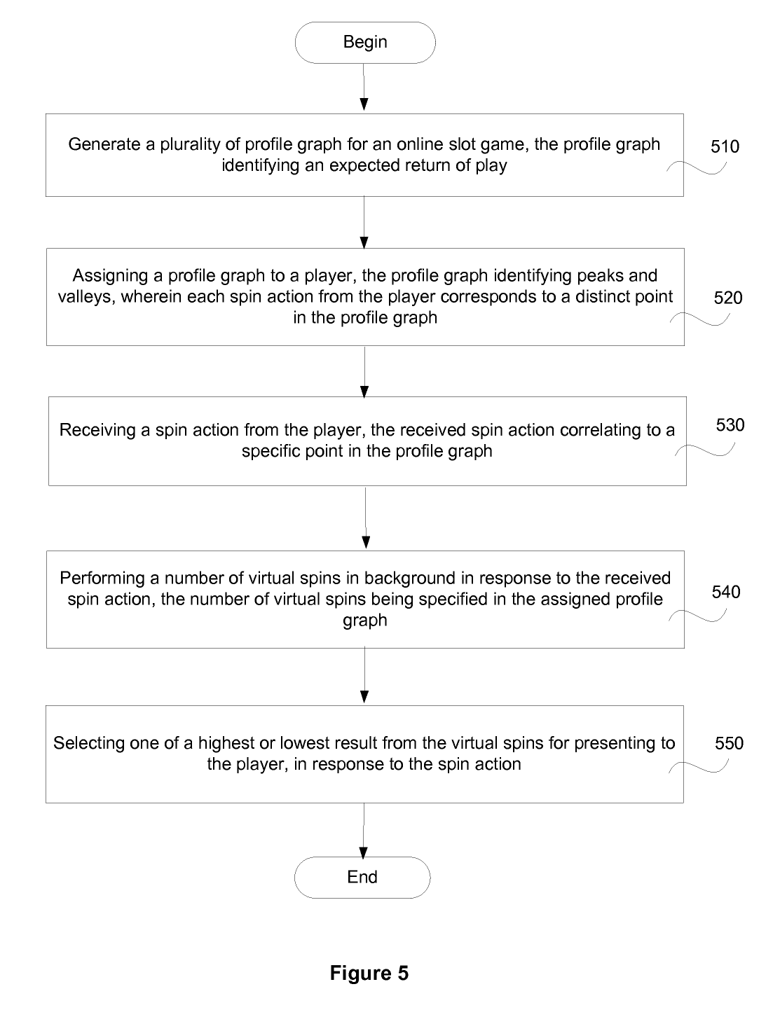

FIG. 5 illustrates an alternate embodiment of a method for determining outcome of an online slot game, in one embodiment of the invention. The method begins at operation 510 wherein a plurality of profile graphs is generated for the online slot game. Each of the plurality of profile graphs is associated with a specific expected return of play. A profile graph is assigned to a player, in response to the player initiating a game play of the online slot game, as illustrated in operation 520. The profile graph assigned to the player identifies peaks and valleys with each spin action from the player corresponding to a distinct point in the profile graph.

During game play, the player initiates a spin action. The spin action from the player is received at the game manager executing the game play of the online game on the server, which correlates the spin action to a specific point in the profile graph assigned for the player, as illustrated in operation 530. The specific point in the profile graph identifies the number of virtual spins that needs to be performed in the background, in response to the spin action corresponding to the specific point.

The game manager performs the number of virtual spins specified for the point in the profile graph corresponding to the spin action, as illustrated in operation 540. One of the highest or lowest result from the virtual spins is selected for presenting to the player, in response to the spin action, as illustrated in operation 550. The highest or lowest result is selected based on the position of the point in the profile graph. For example, if the point is disposed in one of the peaks of the profile graph, the highest result from the number of virtual spins is selected for presenting to the player. On the other hand, if the point is disposed in one of the valleys of the profile graph, the lowest result from the number of virtual spins is selected for presenting to the player. The results from the virtual spins for different points of the profile graph presented to the user include streaks of wins and losses. The winning and losing streaks eventually average out to the expected game play return specified in the profile graph.

The various embodiments of the invention provide ways to determine outcome of an online game by managing the winning and losing streaks within an online game using virtual spins so as to provide a desirable expected return of play. The system determines the type of experience that a player needs to have for the online slot game to keep the player engaged and interested and selects a profile graph that provides such an experience. Other advantages of the various embodiments can be envisioned by one skilled in the art.

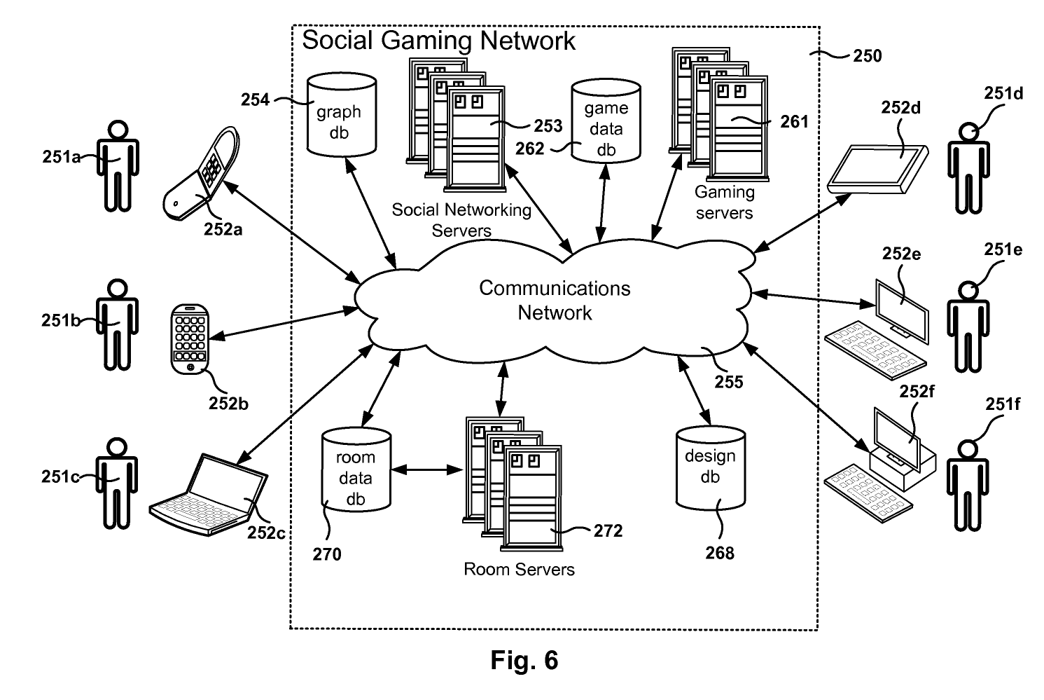

FIG. 6 shows a block diagram illustrating exemplary social-gaming network architecture, according to one embodiment. In some implementations, a plurality of players (e.g., 251a-251f) may be utilizing a social gaming network 250. Each player interacts with the social gaming network via one or more client devices (e.g., client devices 252a-252f). The clients may communicate with each other and with other entities affiliated with the gaming platform via communications network 255. Further, the players may be utilizing a social networking service provided by a social networking server (e.g., social networking servers 253) to interact with each other.

When a player provides an input into the player's client device, the client device may in response send a message via the communications network to the social networking server. The social networking server may update the player profile, save the message to a database, send messages to other players, etc. The social gaming network may include a social graph database 254, which stores player relationships, social player profiles, player messages, and player social data.

The gaming servers 261 host one or more gaming applications, and perform the computations necessary to provide the gaming features to the players and clients. One or more gaming databases 262 store data related to the gaming services, such as the gaming applications and modules, virtual gaming environment data, player gaming session data, player scores, player virtual gaming profiles, game stage levels, etc. The gaming servers may utilize the data from the gaming databases to perform the computations related to providing gaming services for the players.

Room Servers 272 manage the slot rooms system in the game, including the creation, tracking, expiration, abandonment, and deletion of rooms. In addition, a room database 270 holds room information, and design db 268 holds information data.

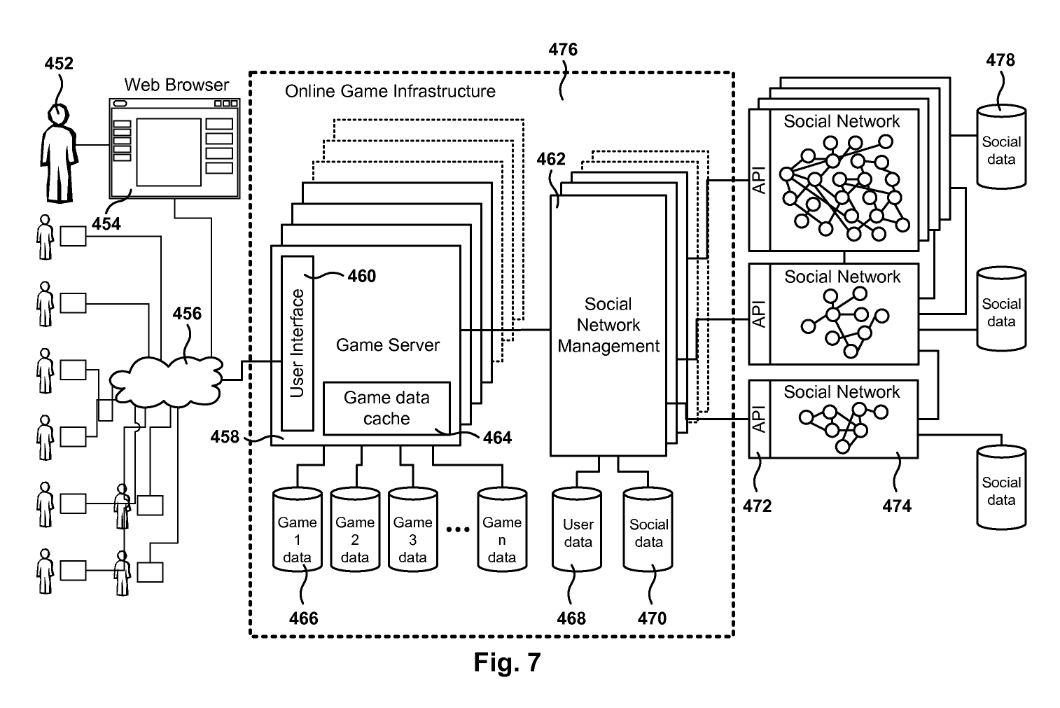

FIG. 7 illustrates an implementation of an online game infrastructure, according to one embodiment. The online game infrastructure 476 includes one or more game servers 458, web servers (not shown), one or more social network management servers 462, and databases to store game related information. In one embodiment, game server 458 provides a user interface 460 for players 452 to play the online game. In one embodiment, game server 458 includes a Web server for players 452 to access the game via web browser 454, but the Web server may also be hosted in a server different from game server 458. Network 456 interconnects players 452 with the one or more game servers 458.

Each game server 458 has access to one or more game databases 466 for keeping game data. In addition, a single database can store game data for one or more online games. Each game server 458 may also include one or more levels of caching. Game data cache 464 is a game data cache for the game data stored in game databases 466. For increased performance, caching may be performed in several levels of caching. For instance, data more frequently used is stored in a high priority cache, while data requiring less access during a session will be cached and updated less frequently.

The number of game servers 458 changes over time, as the gaming platform is an extensible platform that changes the number of game servers according to the load on the gaming infrastructure. As a result, the number of game servers will be higher during peak playing times, and the number of game servers will be lower during off-peak hours. In one embodiment, the increase or decrease of bandwidth is executed automatically, based on current line usage or based on historical data.

One or more social network management servers 462 provide support for the social features incorporated into the online games. The social network management servers 462 access social data 478 from one or more social networks 474 via Application Programming Interfaces (API) 472 made available by the social network providers. An example of a social network is Facebook®, but it is possible to have other embodiments implemented in other social networks. Each social network 474 includes social data 478, and this social data 478, or a fraction of the social data, is made available via API 472. As in the case of the game servers, the number of social network management servers 462 that are active at a point in time changes according to the load on the infrastructure. As the demand for social data increases, the number of social network management servers 462 increases. Social network management servers 462 cache user data in database 468, and social data in database 470. The social data may include the social networks where a player is present, the social relationships for the player, the frequency of interaction of the player with the social network and with other players, etc. Additionally, the user data kept in database 468 may include the player's name, demographics, e-mail, games played, frequency of access to the game infrastructure, etc.

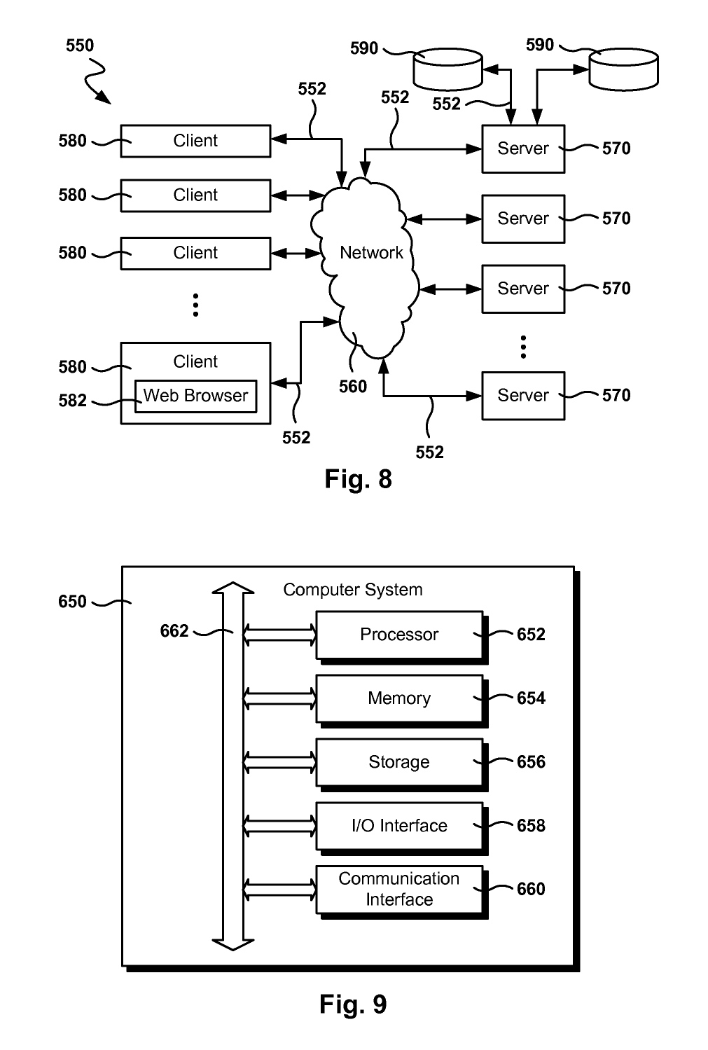

It is noted that the embodiment illustrated in FIG. 8 is an exemplary online gaming infrastructure. Other embodiments may utilize different types of servers, databases, APIs, etc., and the functionality of several servers can be provided by a single server, or the functionality can be spread across a plurality of distributed servers. The embodiment illustrated in FIG. 8 should therefore not be interpreted to be exclusive or limiting, but rather exemplary or illustrative.

FIG. 8 illustrates an example network environment 550 suitable for implementing embodiments. Network environment 550 includes a network 560 coupling one or more servers 570 and one or more clients 580 to each other. In particular embodiments, network 560 is an intranet, an extranet, a virtual private network (VPN), a local area network (LAN), a wireless LAN (WLAN), a wide area network (WAN), a metropolitan area network (MAN), a portion of the Internet, another network, or a combination of two or more such networks 560.

One or more links 552 couple a server 570 or a client 580 to network 560. In particular embodiments, one or more links 552 each includes one or more wired, wireless, or optical links 552. In particular embodiments, one or more links 552 each includes an intranet, an extranet, a VPN, a LAN, a WLAN, a WAN, a MAN, a portion of the Internet, or another link 552 or a combination of two or more such links 552.

Each server 570 may be a stand-alone server or may be a distributed server spanning multiple computers or multiple datacenters. Servers 570 may be of various types, such as, for example and without limitation, slots server, jackpot server, gambling server, web server, news server, mail server, message server, advertising server, file server, application server, exchange server, database server, or proxy server. Each server 570 may include hardware, software, embedded logic components, or a combination of two or more such components for carrying out the appropriate functionalities implemented or supported by server 570. For example, a web server is generally capable of hosting websites containing web pages or particular elements of web pages. More specifically, a web server may host HyperText Markup Language (HTML) files or other file types, or may dynamically create or constitute files upon a request, and communicate them to clients 580 in response to Hypertext Transfer Protocol (HTTP) or other requests from clients 580. A mail server is generally capable of providing electronic mail services to various clients 580. A database server is generally capable of providing an interface for managing data stored in one or more data stores.

In particular embodiments, one or more data storages 590 may be communicatively linked to one or more servers 570 via one or more links 552. Data storages 590 may be used to store various types of information. The information stored in data storages 590 may be organized according to specific data structures. In particular embodiments, each data storage 590 may be a relational database. Particular embodiments may provide interfaces that enable servers 570 or clients 580 to manage, e.g., retrieve, modify, add, or delete, the information stored in data storage 590.

In particular embodiments, each client 580 may be an electronic device including hardware, software, or embedded logic components or a combination of two or more such components and capable of carrying out the appropriate functionalities implemented or supported by client 580. For example and without limitation, a client 580 may be a desktop computer system, a notebook computer system, a notebook computer system, a handheld electronic device, or a mobile telephone. A client 580 may enable a network player at client 580 to access network 580. A client 580 may enable its player to communicate with other players at other clients 580. Further, each client 580 may be a computing device, such as a desktop computer or a work station, or a mobile device, such as a notebook computer, a network computer, or a smart telephone.

In particular embodiments, a client 580 may have a web browser 582, such as Microsoft Internet Explorer, Google Chrome, Or Mozilla Firefox, and may have one or more add-ons, plug-ins, or other extensions. A player at client 580 may enter a Uniform Resource Locator (URL) or other address directing the web browser 582 to a server 570, and the web browser 582 may generate a Hyper Text Transfer Protocol (HTTP) request and communicate the HTTP request to server 570. Server 570 may accept the HTTP request and communicate to client 580 one or more Hyper Text Markup Language (HTML) files responsive to the HTTP request. Client 580 may render a web page based on the HTML files from server 570 for presentation to the user. The present disclosure contemplates any suitable web page files. As an example and not by way of limitation, web pages may render from HTML files, Extensible Hyper Text Markup Language (XHTML) files, or Extensible Markup Language (XML) files, according to particular needs. Such pages may also execute scripts such as, for example and without limitation, those written in Javascript, Java, Microsoft Silverlight, combinations of markup language and scripts such as AJAX (Asynchronous Javascript and XML), and the like. Herein, reference to a web page encompasses one or more corresponding web page files (which a browser may use to render the web page) and vice versa, where appropriate.

Web browser 582 may be adapted for the type of client 580 where the web browser executes. For example, a web browser residing on a desktop computer may differ (e.g., in functionalities) from a web browser residing on a mobile device. A user of a social networking system may access the website via web browser 582.

FIG. 9 illustrates an example computer system 650 for implementing embodiments. In particular embodiments, software running on one or more computer systems 650 performs one or more operations of one or more methods described or illustrated herein or provides functionality described or illustrated herein. Although methods for implementing embodiments were described with a particular sequence of operations, it is noted that the method operations may be performed in different order, or the timing for the execution of operations may be adjusted, or the operations may be performed in a distributed system by several entities, as long as the processing of the operations are performed in the desired way.

As example and not by way of limitation, computer system 650 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, computer system 650 may include one or more computer systems 650; be stand-alone or distributed; span multiple locations; span multiple machines; or reside in a cloud, which may include one or more cloud components in one or more networks. The one or more computer systems 650 may perform in real time or in batch mode one or more operations of one or more methods described or illustrated herein.

In particular embodiments, computer system 650 includes a processor 652, memory 654, storage 656, an input/output (I/O) interface 658, a communication interface 660, and a bus 662. Although this disclosure describes and illustrates a particular computer system having a particular number of particular components in a particular arrangement, embodiments may be implemented with any suitable computer system having any suitable number of any suitable components in any suitable arrangement.

In particular embodiments, processor 652 includes hardware for executing instructions, such as those making up a computer program. As an example and not by way of limitation, to execute instructions, processor 652 may retrieve (or fetch) the instructions from an internal register, an internal cache, memory 654, or storage 656; decode and execute them; and then write one or more results to an internal register, an internal cache, memory 654, or storage 656. The present disclosure contemplates processor 652 including any suitable number of any suitable internal registers, where appropriate. Where appropriate, processor 652 may include one or more arithmetic logic units (ALUs); be a multi-core processor; or include one or more processors 652. Although this disclosure describes and illustrates a particular processor, this disclosure contemplates any suitable processor.

In particular embodiments, memory 654 includes main memory for storing instructions for processor 652 to execute, or data that can be manipulated by processor 652. As an example and not by way of limitation, computer system 650 may load instructions from storage 656 or another source (such as, for example, another computer system 650) to memory 654. Processor 652 may then load the instructions from memory 654 to an internal register or internal cache. During or after execution of the instructions, processor 652 may write one or more results (which may be intermediate or final results) to the internal register or internal cache. Processor 652 may then write one or more of those results to memory 654. One or more memory buses (which may each include an address bus and a data bus) may couple processor 652 to memory 654. Bus 662 may include one or more memory buses, as described below. One or more memory management units (MMUs) reside between processor 652 and memory 654 and facilitate accesses to memory 654 requested by processor 652. Memory 654 includes random access memory (RAM).

As an example and not by way of limitation, storage 656 may include a Hard Disk Drive (HDD), a floppy disk drive, flash memory, an optical disc, a magneto-optical disc, magnetic tape, or a Universal Serial Bus (USB) drive or a combination of two or more of these. Storage 656 may include removable or non-removable (or fixed) media, where appropriate. In particular embodiments, storage 656 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these.

In particular embodiments, I/O interface 658 includes hardware, software, or both providing one or more interfaces for communication between computer system 650 and one or more I/O devices. One or more of these I/O devices may enable communication between a person and computer system 650. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these.

Communication interface 660 includes hardware, software, or both providing one or more interfaces for communication between computer system 650 and one or more other computer systems 650 on one or more networks. As an example and not by way of limitation, communication interface 660 may include a network interface controller (NIC) or network adapter for communicating with an Ethernet or other wire-based network or a wireless NIC (WNIC) or wireless adapter for communicating with a wireless network, such as a WI-FI network. As an example, computer system 650 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these.

In particular embodiments, bus 662 includes hardware, software, or both coupling components of computer system 650 to each other. As an example and not by way of limitation, bus 662 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or another suitable bus or a combination of two or more of these. Bus 662 may include one or more buses 662, where appropriate. Although this disclosure describes and illustrates a particular bus, this disclosure contemplates any suitable bus or interconnects.

Herein, reference to a computer-readable storage medium encompasses one or more non-transitory, tangible computer-readable storage media possessing structure that may store a computer program or data. As an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a Secure Digital card, a Secure Digital drive, or another suitable computer-readable storage medium or a combination of two or more of these, where appropriate. Herein, reference to a computer-readable storage medium excludes any medium that is not eligible for patent protection under 35 U.S.C. §101.

One or more embodiments can also be fabricated as computer readable code on a non-transitory computer readable medium. Herein, reference to software may encompass one or more applications, bytecode, one or more computer programs, one or more executables, one or more instructions, logic, machine code, one or more scripts, or source code, and vice versa, where appropriate.

The present disclosure encompasses all changes, substitutions, variations, alterations, and modifications to the example embodiments herein that a person having ordinary skill in the art would comprehend.

What is claimed is:

1. A method for determining outcome of an online slot game, comprising:
identifying a user account for a player;
identifying a profile associated with the user account of the player for the slot game, the profile defining specific expected return for the slot game;
receiving a spin action from the player during game play of the slot game;
determining number of virtual spins that needs to be performed in background for the received spin action, the number of virtual spins determined based on the profile of the player; and
selecting one of a highest result or a lowest result from the virtual spins for presenting to the player, in response to the spin action,
wherein the method operations are performed by a processor.

2. The method of claim 1, wherein the profile is associated with profile graph data of a profile graph, the profile graph data identifying a plurality of peaks and valleys defined in the profile graph, wherein the peaks represent a higher probability of generating winning results and the valleys represent a higher probability of generating losing results, wherein each spin action corresponds to a particular point in the profile graph.

3. The method of claim 2, wherein the profile graph is pre-defined for a specific expected return for the slot game.

4. The method of claim 2, wherein the profile graph for the player is selected from a plurality of predefined profile graphs defined for the slot game, based on the player's prior gaming history.

5. The method of claim 2, wherein the profile graph for the player with no prior gaming history is selected so as to provide higher expected return for the slot game.

6. The method of claim 2, wherein the number of virtual spins for different points within the peak and for each point within the valley in the identified profile graph are same.

7. The method of claim 2, wherein the number of virtual spins for different points within the peak and for different points within the valley in the identified profile graph are different.

8. The method of claim 2, wherein the selecting of the highest or the lowest result of the virtual spins is based on whether the spin action is associated with the point at the peak or at the valley of the profile graph.

9. The method of claim 1, wherein the virtual spins use a random number generator for generating the results.

10. The method of claim 2, wherein the profile graph identified for the player is specific to a player session.

11. A programming algorithm provided within a game manager of an online slot game, the programming algorithm including program logic which when executed by a processor enables determining outcome of an online slot game, the programming algorithm includes,
program logic to identify a user account for a player;
program logic to generate a plurality of profile graphs based on expected return of play for the online slot game, each profile graph defined by a template with peaks and valleys, wherein the peaks represent a higher probability of producing winning spin results and valleys represent a higher probability of producing losing spin results, wherein each point in the profile graph corresponds to a spin action received from a player;
program logic to identify a select one of the plurality of profile graphs associated with the user account of the player during game play of the online slot game, the select profile graph being identified for a specific game play session;
program logic to determine number of virtual spins that needs to be performed in background for each spin action received from the player during game play of the slot game, the number of virtual spins determined based on the identified profile graph of the player; and
program logic to select one of a highest spin result or a lowest spin result from the virtual spins for presenting to the player, for each spin action received from the player,
wherein the number of virtual spins and the selection of the corresponding spin result is based on location of the point within the selected profile graph that corresponds to the spin action received from the player.

12. The programming algorithm of claim 11, wherein the profile graph associated with the player is selected based on expected game play return for the player of the slot game.

13. The programming algorithm of claim 11, wherein the profile graph selected for the player is based on prior gaming history of the player.

14. The programming algorithm of claim 13, wherein the prior gaming history provides information related to prior game play of the online slot game.

15. The programming algorithm of claim 13, wherein the prior gaming history provides information related to prior game play of the online slot game and other online games played by the player.

16. The programming algorithm of claim 13, wherein the profile graph for the player with no prior gaming history is selected so as to provide higher expected return for the slot game.

17. The programming algorithm of claim 11, wherein the number of virtual spins defined for different points in the peak and different points in the valley in the identified profile graph are different.

18. The programming algorithm of claim 11, wherein the selection of the highest or the lowest result of the virtual spins is based on whether the point corresponding to the spin action is associated with the point at the peak or at the valley of the identified profile graph.

19. The programming algorithm of claim 11, wherein the virtual spins use a random number generator for generating the spin results.
